(19) United States
(12) Patent Application Publication
(10) Pub. No.: US 2015/0108929 A1
(43) Pub. Date: Apr. 23, 2015

(54) POWER CONTROLLER

(71) Applicant: Toyota Jidosha Kabushiki Kaisha, Toyota-shi Aichi-ken (JP)

(72) Inventors: Daigo Nobe, Toyota-shi Aichi-ken (JP); Ryoji Sato, Toyohashi-shi Aichi-ken (JP); Kazuhito Hayashi, Inazawa-shi Aichi-ken (JP)

(21) Appl. No.: 14/338,694

(22) Filed: Jul. 23, 2014

(30) Foreign Application Priority Data
Oct. 17, 2013 (JP) 2013-216200

(51) Int. Cl. H02P 6/08

(52) U.S. Cl. CPC H02P 6/085
USPC 318/400.3

(57) ABSTRACT

A power controller includes a boost converter, an inverter, and a control unit controlling the output voltage of the boost converter and the carrier frequency of the inverter. The control unit includes a carrier frequency reducing program which reduces the carrier frequency to an LC resonance upper limit frequency while maintaining a set value of the output voltage of the boost converter at a system loss minimization voltage at the time of reduction of the carrier frequency from the set frequency, and a voltage varying program which changes the carrier frequency to a first varied frequency calculated based on a first predetermined temperature or lower and the temperatures of the respective switching elements, and changes the set value of the output voltage of the boost converter to a voltage at which the LC resonance upper limit frequency becomes the first varied frequency.

### PRIORITY INFORMATION

This application claims priority to Japanese Patent Application No. 2013-216200, filed on Oct. 17, 2013, which is incorporated herein by reference in its entirety.

### TECHNICAL FIELD

The present invention relates to a structure of a power controller which boosts battery voltage and supplies the boosted voltage to a motor, and to an operation method of this controller.

### BACKGROUND ART

An electric motor vehicle, such as an electric automobile driven by a motor, and a hybrid automobile driven by outputs of a motor and an engine, includes a power controller which boosts voltage of a power source battery using a boost converter, converts DC power after voltage boost by the boost converter into AC power using an inverter, and supplies the AC power to a vehicle driving motor.

The inverter included in the power controller converts DC power into AC power such as three-phase AC power by turning a plurality of switching elements on and off at a carrier frequency. The switching elements generate heat by the on-off operation, and a cooling device is equipped for cooling the switching elements. The amount of heat generated from the switching elements increases as the current flowing in the switching elements becomes larger. Accordingly, the temperatures of the switching elements become excessively high in some cases, depending on the running condition of the vehicle. Excessive increase in the temperatures of the switching elements may shorten the life of the switching elements, and so the temperatures of the switching elements need to be controlled such that the temperatures do not exceed a predetermined temperature.

One method considered to meet this necessity is a method which regulates the current flowing in the switching elements when the temperatures of the switching elements become the predetermined temperature or higher. In other words, this method regulates the output torque of the motor and reduces AC power supplied to the motor, that is, decreases current flowing in the switching elements to reduce increase in the temperatures of the switching elements. According to this method, however, the drivability of the vehicle deteriorates. For overcoming this drawback, such a method is proposed which decreases not the torque of the motor but the carrier frequency of the inverter to lower the temperatures of the switching elements (e.g., see JP 9-121595 A).

### PRIOR ART DOCUMENTS

### Patent Document

### SUMMARY OF THE INVENTION

According to a typical power controller, a boost converter includes a reactor, while an inverter includes a smoothing capacitor which smoothes DC current received from the boost converter and supplies the smoothed DC current to the respective switching elements. Accordingly, an LC circuit is formed by the reactor (L) of the boost converter and the smoothing capacitor (C) of the inverter inside the power controller equipped with the boost converter and the inverter. The LC circuit has a frequency band generating LC resonance. Therefore, when the carrier frequency enters the frequency band generating LC resonance as a result of reduction of the carrier frequency as described in JP 9-121595 A, LC resonance may be generated. With generation of LC resonance, the output voltage of the boost converter oscillates. In this condition, overvoltage or overcurrent caused by the oscillation of the voltage may shorten the life of the switching elements or the motor.

There is another method which gives attention to the point that the frequency band generating LC resonance is variable according to the output voltage of the boost converter (voltage applied to the smoothing capacitor). This method decreases the carrier frequency and raises the output voltage of the boost converter to prevent entrance of the carrier frequency into the frequency band generating LC resonance by reduction of the frequency generating LC resonance when the temperatures of the switching elements become higher. However, under the adjusted condition of the output voltage of the boost converter to a voltage minimizing the total power loss of the system including the inverter and the motor, the total power loss of the system increases when the output voltage of the boost converter is raised.

Moreover, problems similar to these problems may be caused when the temperature of the motor rises as well as the temperatures of the switching elements.

It is an object of the present invention to provide a technology capable of preventing deterioration of the total power loss of a system while reducing a rise in the temperatures of electric components such as switching elements and a motor at the time of the rise of the temperatures of the electric components.

### Means for Solving the Problems

A power controller of the present invention includes: a battery; a boost converter containing a reactor, and boosting voltage of DC power supplied from the battery to output the voltage-boosted DC power; an inverter containing a smoothing capacitor, and converting the voltage-boosted DC power supplied from the boost converter into AC power by turning a plurality of switching elements on and off at a carrier frequency to supply the AC power to a motor; temperature sensors detecting the temperatures of the respective switching elements; and a control unit controlling the output voltage of the boost converter and the carrier frequency of the inverter, wherein an LC circuit is formed by the reactor and the smoothing capacitor, the carrier frequency is set to a frequency higher than an LC resonance upper limit frequency corresponding to the maximum frequency at which LC resonance is generated in the LC circuit, the control unit includes carrier frequency reducing means which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and voltage varying means which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.

In the power controller of the present invention, it is preferable that the carrier frequency reducing means reduces the set value of the carrier frequency from the set frequency to the LC resonance upper limit frequency while maintaining the temperatures of the respective switching elements detected by the respective temperature sensors at least at the first predetermined temperature.

In the power controller of the present invention, it is preferable that the carrier frequency reducing means determines the reduction rate of the carrier frequency with time in accordance with the increase rates of the temperatures of the respective switching elements with time detected by the temperature sensors prior to the start of reduction of the set value of the carrier frequency.

It is preferable that the power controller of the present invention further includes a motor temperature sensor detecting the temperature of the motor, wherein the voltage varying means changes the set value of the carrier frequency to a second varied frequency calculated based on a second predetermined temperature and the temperature of the motor detected by the motor temperature sensor, and changes the set value of the output voltage of the boost converter to a voltage at which the LC resonance upper limit frequency becomes the second varied frequency at the time of reduction of the set value of the carrier frequency from the set frequency to the LC resonance upper limit frequency.

In the power controller of the present invention, it is preferable that the carrier frequency reducing means reduces the set value of the carrier frequency from the set frequency to the LC resonance upper limit frequency while maintaining the temperature of the motor detected by the motor temperature sensor at the second predetermined temperature.

In the power controller of the present invention, it is preferable that the carrier frequency reducing means determines the reduction rate of the carrier frequency with time in accordance with the increase rate of the temperature of the motor with time detected by the motor temperature sensor prior to the start of reduction of the set value of the carrier frequency.

A power controller of the present invention includes: a battery; a boost converter containing a reactor, and boosting voltage of DC power supplied from the battery to output the voltage-boosted DC power; an inverter containing a smoothing capacitor, and converting the voltage-boosted DC power supplied from the boost converter into AC power by turning a plurality of switching elements on and off at a carrier frequency to supply the AC power to a motor; temperature sensors detecting the temperatures of the respective switching elements; and a control unit containing a CPU and controlling the output voltage of the boost converter and the carrier frequency of the inverter, wherein an LC circuit is formed by the reactor and the smoothing capacitor, the carrier frequency is set to a frequency higher than an LC resonance upper limit frequency corresponding to the maximum frequency at which LC resonance is generated in the LC circuit, the control unit performs by using the CPU, a carrier frequency reducing program which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and a voltage varying program which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.

In an operation method of a power controller, the power controller includes: a battery; a boost converter containing a reactor, and boosting voltage of DC power supplied from the battery to output the voltage-boosted DC power; an inverter containing a smoothing capacitor, and converting the voltage-boosted DC power supplied from the boost converter into AC power by turning on and off a plurality of switching elements at a carrier frequency to supply the AC power to a motor; and temperature sensors detecting the temperatures of the respective switching elements, with an LC circuit being formed by the reactor and the smoothing capacitor of the power controller, and the carrier frequency of the power controller being set to a frequency higher than an LC resonance upper limit frequency corresponding to the maximum frequency at which LC resonance is generated in the LC circuit, the method including a carrier frequency reducing step which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and a voltage varying step which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.

### Advantage of the Invention

An advantage provided according to the present invention is to prevent deterioration of the total power loss of a system while reducing a rise in the temperatures of electronic components such as switching elements and a motor at the time of the rise of the temperatures of the electric components.

### BRIEF DESCRIPTION OF THE DRAWINGS

FIG. 1 is a systematic diagram illustrating a control system of an electric motor vehicle on which a power controller according to an embodiment of the present invention is mounted;

FIG. 2 is a flowchart showing an operation of the power controller according to the embodiment of the present invention;

FIG. 3 is a flowchart showing steps for calculating a system loss minimization voltage VH_{tgt0} shown in the flowchart of FIG. 2;

FIGS. 4A to 4C are graphs showing a change of a carrier frequency and a change of a high voltage VH (set value of output voltage of boost converter 20) and a change of a system loss when a carrier frequency is reduced by the power controller according to the embodiment of the present invention;

FIG. 5 is a selection map of reduction amounts Δf_{mg} and Δf_{mg1} of the carrier frequency shown in FIG. 2;

FIG. 6 is a flowchart showing another operation of the power controller according to the embodiment of the present invention;

FIGS. 7A and 7B are selection maps of the carrier frequency and voltage of the power controller according to the embodiment of the present invention;

FIG. 8 is a flowchart showing a further operation of the power controller according to the embodiment of the present invention; and

FIG. 9 is a flowchart showing a still further operation of the power controller according to the embodiment of the present invention.

### DETAILED DESCRIPTION THE INVENTION

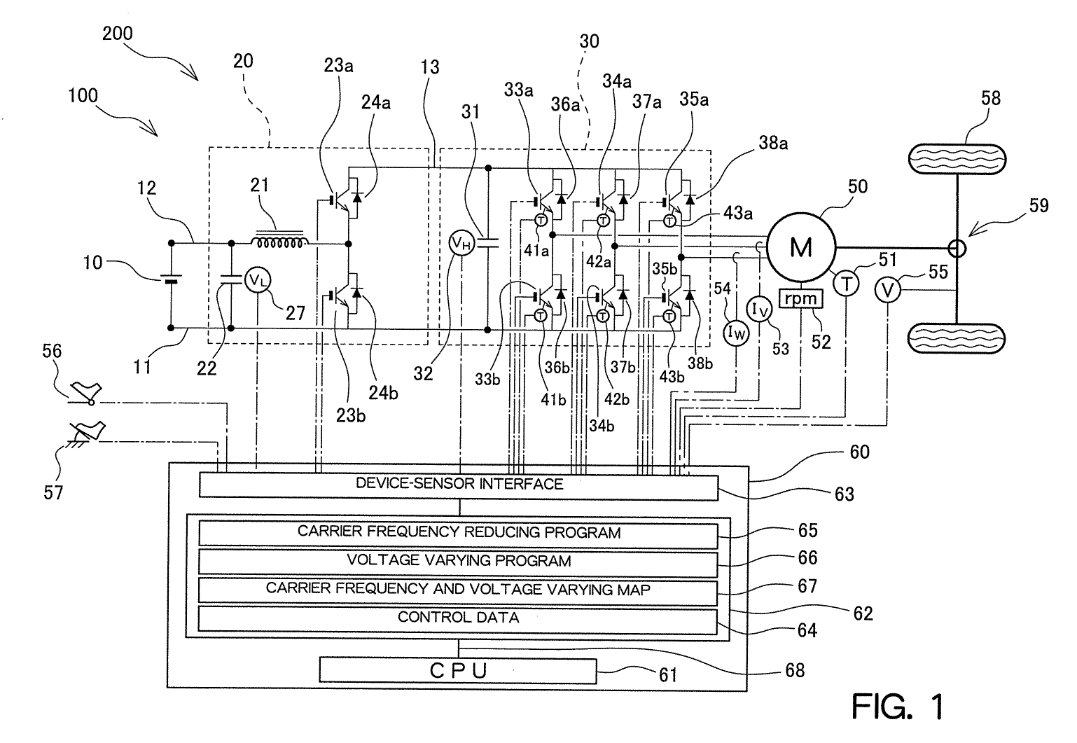

An embodiment according to the present invention is hereinafter described with reference to the drawings. As illustrated in FIG. 1, a power controller 100 according to the present invention includes: a battery 10; a boost converter 20 which boosts voltage of DC power supplied from the battery 10 and outputs voltage-boosted DC power; an inverter 30 which converts the voltage-boosted DC power received from the boost converter 20 into AC power by turning a plurality of switching elements 33a through 35a and 33b through 35b on and off at a carrier frequency f_{mg}, and supplies the AC power to a motor 50 for vehicle driving; and a control unit 60 which controls the output voltage of the boost converter 20 and the carrier frequency f_{mg} of the inverter 30.

The boost converter 20 and the inverter 30 include a grand circuit 11 connected with the negative side of the battery 10 and common to both the boost converter 20 and the inverter 30, a low-voltage circuit 12 connected with the positive side of the battery 10, and a high-voltage circuit 13 corresponding to the positive side output end of the boost converter 20 and the positive side input end of the inverter 30.

The boost converter 20 includes an upper arm switching element 23a disposed between the low-voltage circuit 12 and the high-voltage circuit 13, a lower arm switching element 23b disposed between the grand circuit 11 and the low-voltage circuit 12, a reactor 21 disposed in series with the low-voltage circuit 12, a filter capacitor 22 disposed between the low-voltage circuit 12 and the grand circuit 11, and a low-voltage sensor 27 detecting a low voltage VL at both ends of the filter capacitor 22. Diodes 24a and 24b are connected in anti-parallel with the switching elements 23a and 23b, respectively.

The boost converter 20 turns on the lower arm switching element 23b and turns off the upper arm switching element 23a to receive electrical energy from the battery 10 and accumulate the received energy in the reactor 21. Then, the boost converter 20 turns off the lower arm switching element 23b and turns on the upper arm switching element 23a to boost the voltage using the electrical energy accumulated in the reactor 21 and output the boosted voltage to the high-voltage circuit 13. Accordingly, the output voltage supplied from the boost converter 20 is variable according to the on-off cycle of the switching elements 23a and 23b.

A smoothing capacitor 31 is provided between the grand circuit 11 and the high-voltage circuit 13 on the input side of the inverter 30, that is, on the boost converter 20 side of the inverter 30. The smoothing capacitor 31 converts the variable output voltage received from the boost converter 20 into smooth DC voltage. A high-voltage sensor 32 is attached to the smoothing capacitor 31 to detect a high voltage VH at both ends of the smoothing capacitor 31. The inverter 30 further includes upper arm switching elements 33a through 35a for U, V, and W phases, respectively, and lower arm switching elements 33b through 35b for U, V, and W phases, respectively. These six switching elements 33a through 35a and 33b through 35b are disposed in series between the grand circuit 11 and the high-voltage circuit 13 on the side opposite to the boost converter 20 side with respect to the smoothing capacitor 31. Output lines for U, V, and W phases are connected between the upper arm switching elements 33a through 35a and the lower arm switching elements 33b through 35b, respectively. The respective output lines for U, V, and W phases are connected with input terminals of the motor 50 for U, V, and W phases. Diodes 36a through 38a and 36b through 38b are connected in anti-parallel with the upper arm switching elements 33a through 35a and the lower arm switching elements 33b through 35b, respectively. Temperature sensors 41a through 43a and 41b through 43b are attached to the upper arm switching elements 33a through 35a and the lower arm switching elements 33b through 35b to detect the temperatures of the respective elements. The inverter 30 converts the voltage-boosted DC power received from the boost converter 20 into AC power by turning the six switching elements of the upper arm switching elements 33a through 35a and the lower arm switching elements 33b through 35b on and off at the carrier frequency f_{mg}, and supplies the AC power to the motor 50 for vehicle driving.

The output shaft of the motor 50 for vehicle driving is connected with a driving mechanism 59 of wheels 58 of an electric motor vehicle 200 on which the power controller 100 is mounted. The output shaft of the motor 50 rotates the wheels 58 of the electric motor vehicle 200 by revolutions of the motor 50. Current sensors 53 and 54 are attached to the two output lines for supplying power in V and W phases from the inverter 30 to the motor 50 to detect currents flowing in the corresponding output lines. A resolver 52 detecting the number of revolutions or the rotation angle of a rotor, and a temperature sensor 51 detecting the temperature of a stator of the motor 50, for example, are attached to the motor 50. A vehicle speed sensor 55 detecting the speed of the electric motor vehicle 200 based on the number of revolutions is attached to the driving mechanism 59 of the wheels 58.

The control unit 60 is a computer which contains a CPU 61 for performing calculations and information processing, a memory unit 62, and a device-sensor interface 63 for connecting respective devices and sensors. The CPU 61, the memory unit 62, and the device-sensor interface 63 are connected via a data bus 68. The memory unit 62 stores control data 64, and a carrier frequency reducing program 65, a voltage varying program 66, and a carrier frequency and voltage varying map 67 which will be described later.

The respective switching elements 23a, 23b, 33a through 35a, and 33b through 35b included in the boost converter 20 and the inverter 30 of the power controller 100 are connected with the control unit 60 via the device-sensor interface 63, and so configured as to operate under commands issued from the control unit 60. The low-voltage sensor 27, the high-voltage sensor 32, the respective temperature sensors 41a through 43a, 41b through 43b attached to the respective switching elements 33a through 35a and 33b through 35b of the inverter 30, the current sensors 53 and 54 for V and W phases, the temperature sensor 51 for the motor 50, the resolver 52, the vehicle speed sensor 55, and an accelerator pedal depression amount detection sensor 56 and a brake pedal depression amount detection sensor 57 for detecting the depression amounts of an accelerator pedal and a brake pedal attached to the electric motor vehicle 200 on which the power controller 100 is mounted, are each connected with the device-sensor interface 63 of the control unit 60. The data such as temperatures detected by the respective sensors are inputted to the control unit 60 via the device-sensor interface 63.

The reactor 21 included in the boost converter 20 of the power controller 100 and the smoothing capacitor 31 included in the inverter 30 of the power controller 100 form an LC circuit, in which condition a resonance frequency band generating LC resonance exists. Accordingly, the control unit 60 turns the respective switching elements 33a through 35a and 33b through 35b on and off at the carrier frequency f_{mg} higher than an LC resonance upper limit frequency f_{LC} corresponding to the maximum frequency of the resonance frequency band generating LC resonance in the LC circuit to prevent generation of overvoltage and overcurrent caused by oscillation of the voltage of the high-voltage circuit 13 produced through excitation of the LC circuit by counter electromotive force generated from the motor 50, for example.

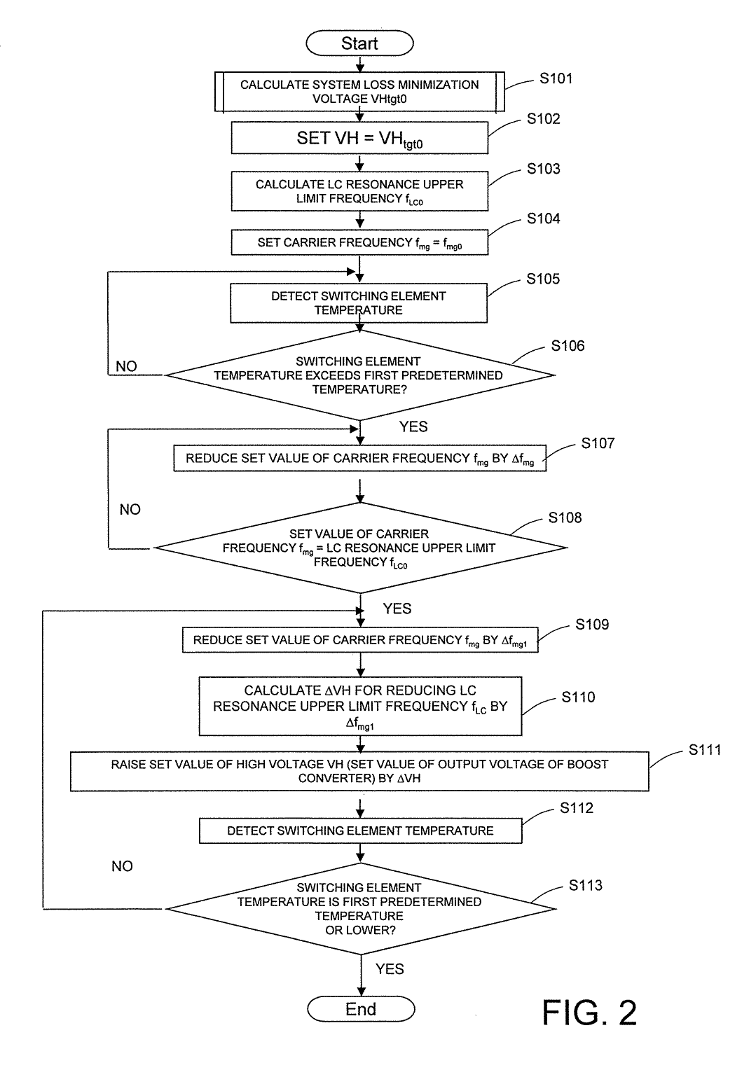

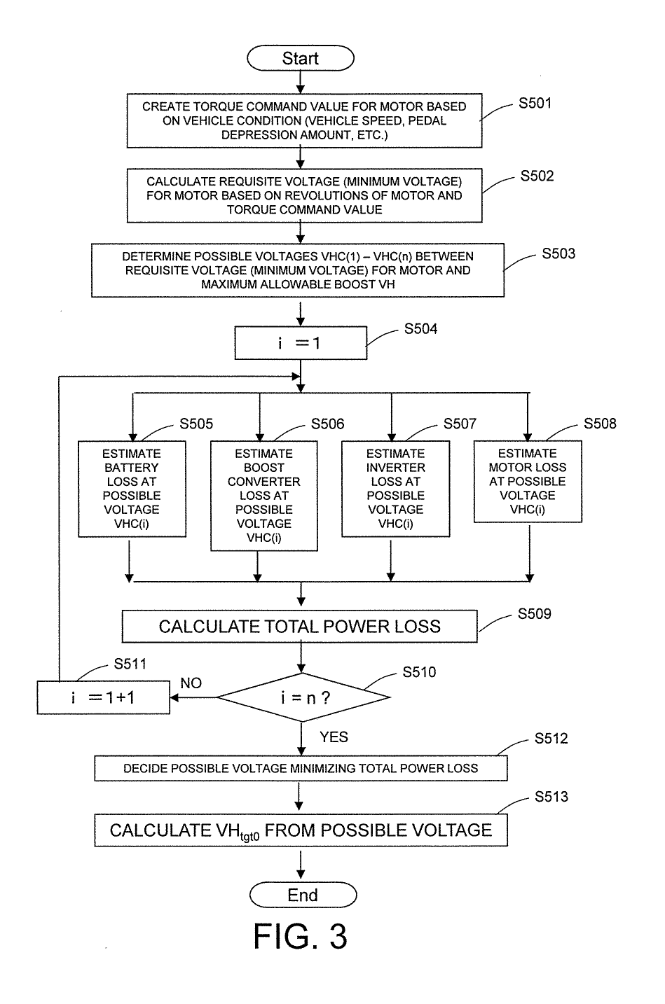

The operation of the power controller 100 having this structure is hereinafter detailed with reference to FIGS. 2 through 5. As shown in step S101 in FIG. 2, the control unit 60 calculates a system loss minimization voltage VH_{tgt0}. The system loss minimization voltage VH_{tgt0} is a high voltage VH (the potential difference between voltages at both ends of the smoothing capacitor 31 or between the grand circuit 11 and the high-voltage circuit 13, and the set value of the output voltage of the boost converter 20) which minimizes the total power loss of the battery loss, the boost converter loss, the inverter loss, and the motor loss. For example, the system loss minimization voltage VH_{tgt0} may be calculated by a calculation method shown in FIG. 3.

Calculation of the system loss minimization voltage VH_{tgt0} is now described with reference to FIG. 3. As shown in step S501 in FIG. 3, the control unit 60 creates a torque command value for the motor 50 based on the vehicle speed and the depression amounts of the respective pedals of the electric motor vehicle 200 detected by the sensors such as the vehicle speed sensor 55, the accelerator pedal depression amount detection sensor 56, and the brake pedal depression amount detection sensor 57 shown in FIG. 1. As shown in step S502 in FIG. 3, the control unit 60 calculates the requisite voltage (minimum voltage) of the motor 50 based on the number of revolutions of the motor 50 detected by the resolver 52 and the created torque command value. As shown in step S503 in FIG. 3, the control unit 60 determines n possible voltages (VHC(1) through VHC(n)) in the range from the calculated requisite voltage (minimum voltage) of the motor 50 to a maximum voltage VHH corresponding to the highest voltage allowed for boosting by the boost converter 20.

As shown in step S504 in FIG. 3, the control unit 60 sets an increment i to 1 as initial setting, and calculates the battery loss, the boost converter loss, the inverter loss, and the motor loss at a possible voltage VHC(i) as shown in steps S505, S506, S507, and S508 in FIG. 3, and to calculate the total power loss as shown in step S509 in FIG. 3. As shown in steps S510 and S511 in FIG. 3, the total power loss is calculated for all of the n possible voltages up to VHC(n) while increasing the increment i by one for each. As shown in step S512 in FIG. 3, the control unit 60 decides the possible voltages minimizing the power loss based on the calculated n total power losses of the n possible voltages VHC(1) through VHC(n). As shown in step S513 in FIG. 3, the control unit 60 calculates the system loss minimization voltage VH_{tgt0} which minimizes the power loss by means of proportional distribution of two voltages selected from the decided possible voltages of the voltages VHC(1) through VHC(n) in accordance with the total power losses of the two selected voltages, for example.

As shown in step S102 in FIG. 2, the control unit 60 sets a set value of the high voltage VH (set value of output voltage of boost converter 20) to the system loss minimization voltage VH_{tgt0} calculated in step S101. As shown in step S103 in FIG. 2, the control unit 60 calculates an LC resonance upper limit frequency f_{LC0}. An LC resonance frequency F_{LC} of an LC circuit containing a voltage-boosting circuit as included in the power controller 100 in FIG. 1 is calculated by the following equation.

F_{LC}=(VL/VH)/(2×π×√(LC)) (Equation 1)

In this equation, the value VL corresponds to the low voltage VL (voltage of battery 10). The value VH corresponds to the high voltage VH (set value of output voltage of boost converter 20). The value L corresponds to the reluctance of the reactor 21. The value C corresponds to the capacitance of the smoothing capacitor.

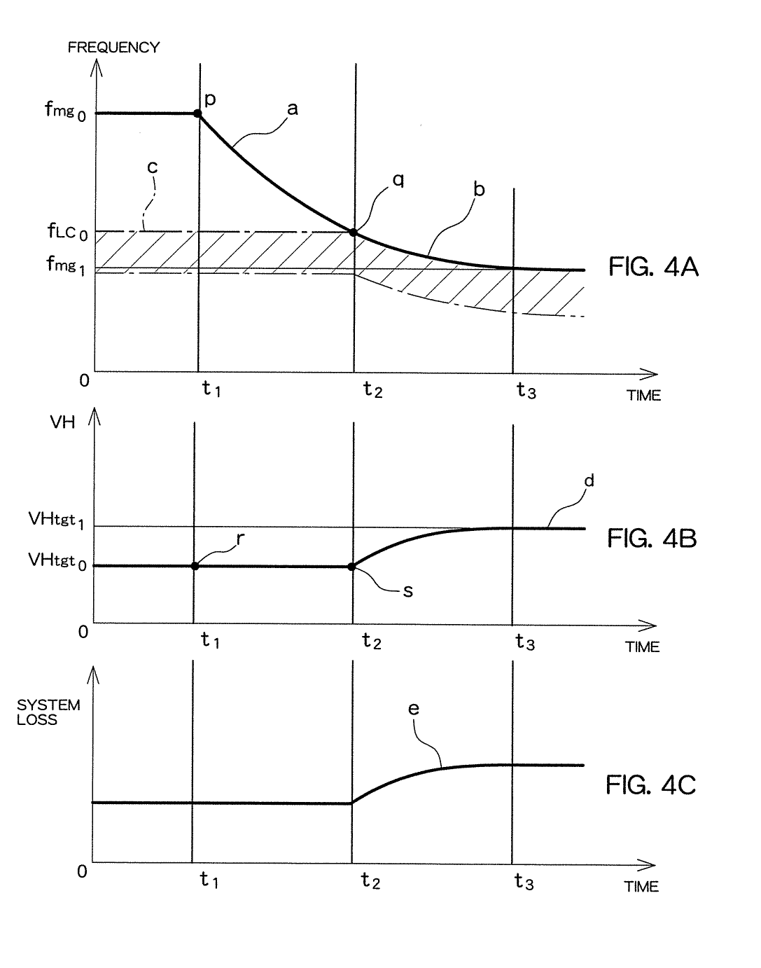

The LC resonance upper limit frequency f_{LC0} is calculated as √2×LC resonance frequency F_{LC}, for example. Since the frequency band generating LC resonance is variable according to the resistance of the LC circuit, the LC resonance upper limit frequency f_{LC0} may be calculated from the LC resonance frequency F_{LC} based on test results or the like. As shown in step S104 in FIG. 2, the control unit 60 sets the carrier frequency f_{mg} to a frequency f_{mg0} higher than the calculated LC resonance upper limit frequency f_{LC0}. A time 0 in FIGS. 4A to 4C indicates the condition of completion of the initial setting discussed above. Solid line “a” in FIG. 4A shows the carrier frequency f_{mg}, and alternate long and short dash line “c” in FIG. 4A shows the LC resonance upper limit frequency f_{LC}, and solid line “d” in FIG. 4B shows the set value of the high voltage VH (set value of output voltage of boost converter 20), and solid line “e” in FIG. 4C shows the system loss. A hatched area below the LC resonance upper limit frequency f_{LC} (alternate long and short dash line “c”) in FIG. 4A indicates the frequency band generating LC resonance.

As shown in step S105 in FIG. 2, the control unit 60 detects the temperatures of the respective switching elements 33a through 35a and 33b through 35b from the respective temperature sensors 41a through 43a and 41b through 43b in FIG. 1 attached to the respective switching elements 33a through 35a and 33b through 35b. As shown in step S106 in FIG. 2, the control unit 60 compares the detected respective temperatures with a first predetermined temperature, and determines whether any of the temperatures of the switching elements 33a through 35a and 33b through 35b exceed the first predetermined temperature. The first predetermined temperature in this context is a temperature at which rated current is allowed to flow in the respective switching elements 33a through 35a and 33b through 35b. When the temperature exceeds the first predetermined temperature, current needs to be regulated. The first predetermined temperature is set to approximately 150° C., for example.

When none of the temperatures of the switching elements 33a through 35a and 33b through 35b exceeds the first predetermined temperature in step S106 in FIG. 2, the control unit 60 returns to step S105 in FIG. 2 and detects the temperatures of the switching elements 33a through 35a and 33b through 35b by the respective temperature sensors 41a through 43a and 41b through 43b. As shown in step S106 in FIG. 2, the control unit 60 repeats determining whether the temperatures exceed the first predetermined temperature to monitor the temperatures of the switching elements 33a through 35a and 33b through 35b.

When any of the temperatures of the switching elements 33a through 35a and 33b through 35b exceeds the first predetermined temperature in step S106 in FIG. 2, the control unit 60 performs the carrier frequency reducing program 65 (carrier frequency reducing means) to decrease the set value of the carrier frequency f_{mg}, which has been set to f_{mg0} corresponding to the initial setting, to the LC resonance upper limit frequency f_{LC0} calculated in step S103 in FIG. 2, while maintaining the high voltage VH (set value of output voltage of boost converter 20) at the system loss minimization voltage VH_{tgt0} corresponding to the initial setting.

When any of the temperatures of the switching elements 33a through 35a and 33b through 35b exceeds the first predetermined temperature as discussed above at a time t1 shown in FIG. 4A the control unit 60 decreases the set value of the carrier frequency f_{mg} by Δf_{mg} per unit time as shown in step S107 in FIG. 2 to decrease the set value of the carrier frequency f_{mg} to the LC resonance upper limit frequency f_{LC0} within the period from the time t₁ and a time t₂. During this period, the high voltage VH (set value of output voltage of boost converter 20) is maintained at the system loss minimization voltage VH_{tgt0} corresponding to the initial setting as indicated by the solid line d in FIG. 4B, a result of which the system loss indicated by the solid line “e” in FIG. 4C does not increase.

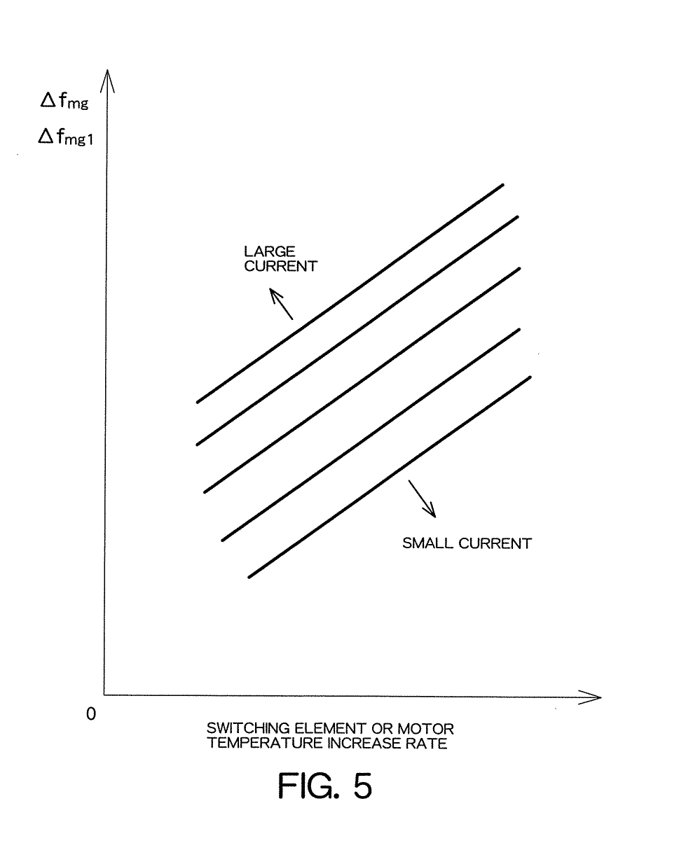

As shown in a map in FIG. 5 (stored in the carrier frequency and voltage varying map 67 of the memory unit 62 shown in FIG. 1), the reduction frequency Δf_{mg} per unit time at the time of reduction of the carrier frequency may be so determined as to increase as the temperature rise rate of the respective switching elements 33a through 35a and 33b through 35b or the motor 50 before or after excess of the first predetermined temperature increases, and to decrease as the corresponding temperature rise rate decreases. In addition, the reduction frequency Δf_{mg} per unit time may be so determined as to increase as the current flowing in the respective switching elements 33a through 35a and 33b through 35b or the motor 50 increases, and to decrease as the corresponding current decreases. In other words, when the temperature rise rate of the respective switching elements 33a through 35a and 33b through 35b is low and when the current is not considerably large, rapid reduction of the temperatures of the respective switching elements 33a through 35a and 33b through 35b is not required. In this case, the value Δf_{mg} per unit time at the time of reduction is lowered, and the period for decreasing the set value of the carrier frequency f_{mg} from the initial setting f_{mg0} to the LC resonance upper limit frequency f_{LC0} is prolonged. In other words, the period between the time t₁ and the time t₂ shown in FIGS. 4A to 4C is prolonged to increase the period when the system loss indicated by the solid line “e” in FIG. 4C does not increase, or to maintain the condition where the system loss is small for a long period. On the other hand, when the temperature rise rate of the respective switching elements 33a through 35a and 33b through 35b is high and when the current is large, that is, when rapid reduction of the temperatures of the respective switching elements 33a through 35a and 33b through 35b is required, the value Δf_{mg} per unit time at the time of reduction is raised to rapidly decrease the number of times of the on-off operation of the switching elements 33a through 35a and 33b through 35b and thereby rapidly lower the temperatures of the switching elements 33a through 35a and 33b through 35b.

After reduction of the set value of the carrier frequency f_{mg} to the LC resonance upper limit frequency f_{LC0} as shown in step S108 in FIG. 2, the control unit 60 performs the voltage varying program 66 (voltage varying means) as shown in steps S109 to S112 in FIG. 2 to change the set value of the carrier frequency f_{mg} to the maximum frequency at which the temperatures of the respective switching elements 33a through 35a and 33b through 35b detected by the respective temperature sensors 41a through 43a, 41b through 43b become the first predetermined temperature or lower, and to change the high voltage VH (set value of output voltage of boost converter 20) to a voltage (varied voltage) at which the LC resonance upper limit frequency f_{LC} becomes a first varied frequency.

At the time t₂ in FIG. 4A, the set value of the carrier frequency f_{mg} becomes the LC resonance upper limit frequency f_{LC0}. As shown in step S109 in FIG. 2, the control unit 60 decreases the set value of the carrier frequency f_{mg} by Δf_{mg1} from the LC resonance upper limit frequency f_{LC0}. In this case, the set value of the carrier frequency f_{mg} becomes lower than the LC resonance upper limit frequency f_{LC0} at which the high voltage VH (set value of output voltage of boost converter 20) becomes the system loss minimization voltage VH_{tgt0} corresponding to the initial setting. As a result, the set value of the carrier frequency f_{mg} enters the LC resonance frequency band. As discussed above, the LC resonance frequency F_{LC} is determined by the (Equation 1), and so the set value of the carrier frequency f_{mg} becomes equivalent to or higher than the LC resonance upper limit frequency f_{LC} when the LC resonance frequency F_{LC} is decreased by raising the high voltage VH (set value of output voltage of boost converter 20). Accordingly, the control unit 60 calculates an increase amount ΔVH of the high voltage VH (set value of output voltage of boost converter 20) which allows reduction of the LC resonance upper limit frequency f_{LC} by Δf_{mg1} as shown in step S110 in FIG. 2. As discussed above (Equation 1), the LC resonance frequency F_{LC} is proportional to the ratio of the low voltage VL to the high voltage VH (set value of output voltage of boost converter 20) (duty ratio: VL/VH). Accordingly, a change amount ΔF_{LC} of the LC resonance frequency F_{LC} is proportional to a change amount Δ(VL/VH) of the ratio (VL/VH) as in the following (Equation 2).

ΔF_{LC}=K₁×Δ(VL/VH) (Equation 2)

The LC resonance upper limit frequency f_{LC} is calculated as √2×LC resonance frequency F_{LC}, for example. Thus, the change amount Δf_{LC} of the LC resonance upper limit frequency f_{LC} is proportional to the change amount Δ(VL/VH) of the ratio (VL/VH) as in the following (Equation 3).

Δf_{LC}=K₂×Δ(VL/VH) (Equation 3)

Accordingly, the increase amount ΔVH of the high voltage VH (set value of output voltage of boost converter 20) which allows reduction of the LC resonance upper limit frequency f_{LC} by Δf_{mg1} is calculated based on the relationship expressed by the following (Equation 4) which substitutes Δf_{mg1} for Δf_{LC} in (Equation 3).

Δf_{mg1}=K₂×Δ(VL/VH) (Equation 4)

After calculating the increase amount ΔVH of the set value of the high voltage VH (set value of output voltage of boost converter 20) which allows reduction of the LC resonance upper limit frequency f_{LC} by Δf_{mg1} in step S110 in FIG. 2, the control unit 60 increases the set value of the high voltage VH (set value of output voltage of boost converter 20) by ΔVH. As a result, the LC resonance upper limit frequency f_{LC} is reduced by Δf_{mg1}, as a result of which the set value of the carrier frequency f_{mg} and the LC resonance upper limit frequency f_{LC} become the same value, that is, (LC resonance upper limit frequency f_{LC0}−Δf_{mg1}) as indicated by a solid line “b” after the time t₂ in FIG. 4A. Accordingly, the set value of the carrier frequency f_{mg} does not become lower than the LC resonance upper limit frequency f_{LC}, and thus does not enter the LC resonance frequency band.

Accordingly, the control unit 60 decreases the set value of the carrier frequency f_{mg} to a value lower than the LC resonance upper limit frequency f_{LC0} corresponding to the initial setting and raises the set value of the high voltage VH (set value of output voltage of boost converter 20) to decrease the number of times of the on-off operation of the respective switching elements 33a through 35a and 33b through 35b for reduction of temperature increase. As shown in step S112 in FIG. 2, the control unit 60 detects the temperatures of the respective switching elements 33a through 35a and 33b through 35b by the respective temperature sensors 41a through 43a and 41b through 43b. As shown in step S113 in FIG. 2, the control unit 60 determines whether the temperatures of the respective switching elements 33a through 35a and 33b through 35b are lowered to the first predetermined temperature or lower. When the temperatures of the respective switching elements 33a through 35a and 33b through 35b are not lowered to the first predetermined temperature or lower, the control unit 60 returns to step S109 and decreases the set value of the carrier frequency f_{mg} by Δf_{mg1}. As shown in step S110 in FIG. 2, the control unit 60 calculates the increase amount ΔVH of the set value of the high voltage VH (set value of output voltage of boost converter 20) which allows reduction of the LC resonance upper limit frequency f_{LC} by Δf_{mg1}. As shown in step S111 in FIG. 2, the control unit 60 repeats the step of increasing the set value of the high voltage VH (set value of output voltage of boost converter 20) by ΔVH until the temperatures of the respective switching elements 33a through 35a and 33b through 35b become the first predetermined temperature or lower. When the temperatures of the respective switching elements 33a through 35a and 33b through 35b become the first predetermined temperature or lower as shown in step S113 in FIG. 2, the control unit 60 stops reduction of the set value of the carrier frequency f_{mg} and raises of the set value of the high voltage VH (set value of output voltage of boost converter 20). The value Δf_{mg1} may be varied according to the temperatures and currents of the switching elements 33a through 35a and 33b through 35b and the motor 50 similarly to the value Δf_{mg} in the map shown in FIG. 5 discussed above.

Accordingly, after the time t₂ in FIGS. 4A to 4C when the set value of the carrier frequency f_{mg} becomes the LC resonance upper limit frequency f_{LC0}, the control unit 60 reduces the carrier frequency f_{mg} little by little (by Δf_{mg1}) and increases the set value of the high voltage VH (set value of output voltage of boost converter 20) little by little (by ΔVH) such that the set value of the carrier frequency f_{mg} and the LC resonance upper limit frequency f_{LC} become the same frequency, until the temperatures of the switching elements 33a through 35a and 33b through 35b become the first predetermined temperature. After a time t₃ in FIGS. 4A to 4C when the temperatures of the switching elements 33a through 35a and 33b through 35b become the first predetermined temperature, the control unit 60 stops reduction of the set value of the carrier frequency f_{mg} and raises of the set value of the high voltage VH (set value of output voltage of boost converter 20). As a result, the set value of the carrier frequency f_{mg} at the time of stopping the reduction of the set value of the carrier frequency f_{mg} and raising of the set value of the high voltage VH (set value of output voltage of boost converter 20) (time t₃ in FIGS. 4A to 4C) becomes the first varied frequency f_{mg1} corresponding to the maximum frequency at which the temperatures of the respective switching elements 33a through 35a and 33b through 35b become the first predetermined temperature or lower. In this condition, the high voltage VH (set value of output voltage of boost converter 20) becomes a varied voltage VH_{tgt1} at which the LC resonance upper limit frequency f_{LC} becomes the first varied frequency f_{mg1}. Accordingly, the power controller 100 in this embodiment only raises the set value of the high voltage VH (set value of output voltage of boost converter 20) up to the minimum voltage at which the temperatures of the respective switching elements 33a through 35a and 33b through 35b become the first predetermined temperature or lower. In other words, it is possible that the voltage rise from the system loss minimization voltage VH_{tgt0} corresponding to the initial setting becomes the minimum, and so a rise in the system loss decreases to the minimum as shown in FIGS. 4A to 4C.

As discussed above, as in the period from the time t₁ to the time t₂ shown in FIGS. 4A to 4C, the power controller 100 in this embodiment maintains the set value of the high voltage VH (set value of output voltage of boost converter 20) at the system loss minimization voltage VH_{tgt0} corresponding to the initial setting and reduces the set value of the carrier frequency f_{mg} to the LC resonance upper limit frequency f_{LC0} while keeping the temperatures of the respective switching elements 33a through 35a and 33b through 35b at temperatures equivalent to or lower than the first predetermined temperature. Accordingly, the power controller 100 can reduce a rise in the system loss during this period while lowering increase in the temperatures of the switching elements 33a through 35a and 33b through 35b. Moreover, as in the period from t₂ to t₃ in FIGS. 4A to 4C, the power controller 100 sets the set value of the carrier frequency f_{mg} to the first varied frequency f_{mg1} corresponding to the maximum frequency at which the temperatures of the respective switching elements 33a through 35a and 33b through 35b become the first predetermined temperature or lower, and sets the set value of the high voltage VH (set value of output voltage of boost converter 20) to the varied voltage VH_{tgt1} at which the LC resonance upper limit frequency f_{LC} becomes the first varied frequency f_{mg1}. In this case, it is possible that the voltage rise from the system loss minimization voltage VH_{tgt0} corresponding to the initial setting of the high voltage VH (set value of output voltage of boost converter 20) decreases to the minimum. Accordingly, the power controller 100 can reduce a rise in the system loss during the period after the time t₂ shown in FIGS. 4A to 4C to the minimum while reducing increase in the temperatures of the respective switching elements 33a through 35a and 33b through 35b.

According to the embodiment described herein, during the period from the time t₂ to the time t₃ shown in FIGS. 4A to 4C, reduction of the set value of the carrier frequency f_{mg} by Δf_{mg1} is repeated to set the set value of the carrier frequency f_{mg} to the first varied frequency f_{mg1} corresponding to the maximum frequency at which the temperatures of the respective switching elements 33a through 35a and 33b through 35b become the first predetermined temperature or lower, and to set the set value of the high voltage VH (set value of output voltage of boost converter 20) to the varied voltage VH_{tgt1} at which the LC resonance upper limit frequency f_{LC} becomes the first varied frequency f_{mg1}. However, the calculated values of the first varied frequency and the varied voltage may be stored in advance in the carrier frequency and voltage varying map 67 of the memory unit 62 shown in FIG. 1, so that the calculated values of the first varied frequency and the varied voltage can be read from the map.

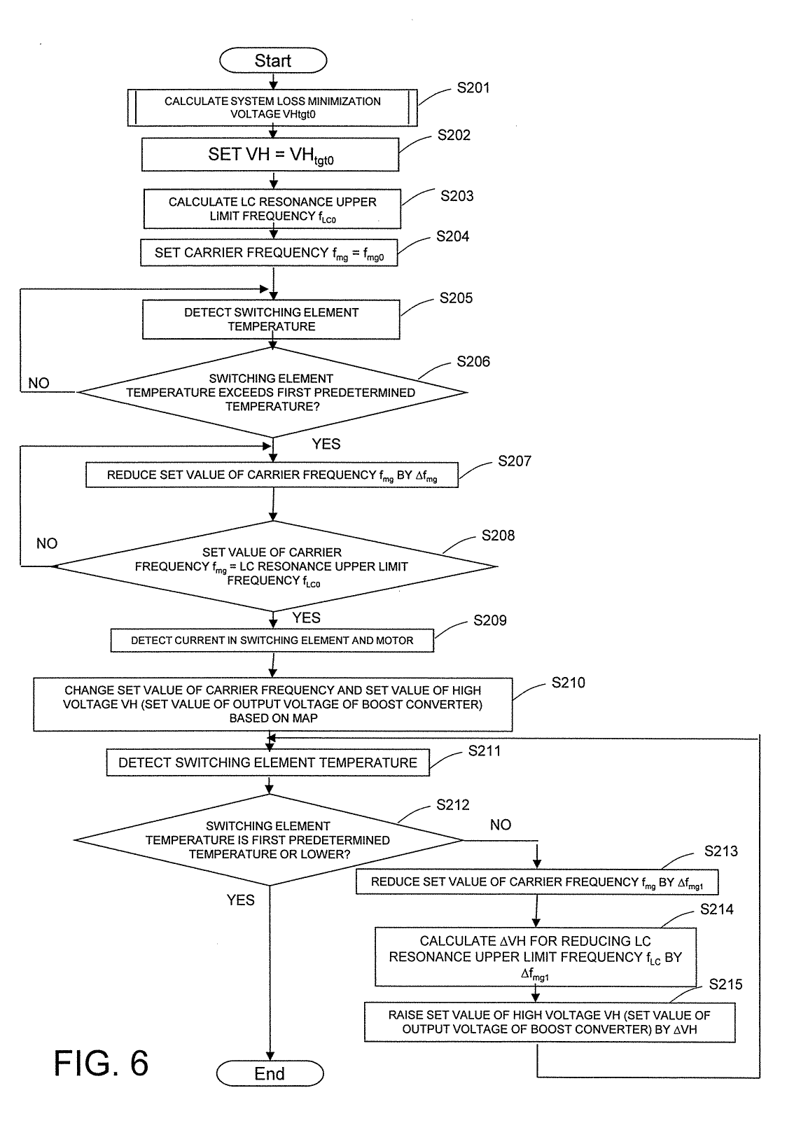

Discussed hereinbelow with reference to FIG. 6 is an operation which stores the calculated values of the first varied frequency and the varied voltage in advance in the carrier frequency and voltage varying map 67 of the memory unit 62 shown in FIG. 1, and reads the calculated values of the first varied frequency and the varied voltage from the map to reduce a rise in the system loss to the minimum. The parts of the operation similar to the corresponding parts discussed in conjunction with FIGS. 2 through 5 are not repeated in FIG. 6.

As shown in step S201 in FIG. 6, the control unit 60 calculates the system loss minimization voltage VH_{tgt0} similarly to step S101 in FIG. 2. As shown in steps S202 to S208 in FIG. 6, the control unit 60 performs the following steps. Initially, the control unit 60 sets the set value of the high voltage VH (set value of output voltage of boost converter 20) to the system loss minimization voltage VH_{tgt0}, calculates the LC resonance upper limit frequency f_{LC0} at the system loss minimization voltage VH_{tgt0}, and sets the set value of the carrier frequency f_{mg} to the frequency f_{mg0} higher than the LC resonance upper limit frequency f_{LC0} similarly to steps S102 through S104 in FIG. 2. Then, the control unit 60 monitors whether the temperatures of the switching elements 33a through 35a and 33b through 35b exceed the first predetermined temperature similarly to steps S105 and S106 in FIG. 2. When any of the temperatures of the switching elements 33a through 35a and 33b through 35b exceed the first predetermined temperature, the control unit 60 lowers the set value of the carrier frequency f_{mg} by Δf_{mg} to decrease the carrier frequency f_{mg} to the LC resonance upper limit frequency f_{LC0} within the period from the time t₁ to the time t₂ shown in FIGS. 4A to 4C similarly to steps S107 and S108 in FIG. 2.

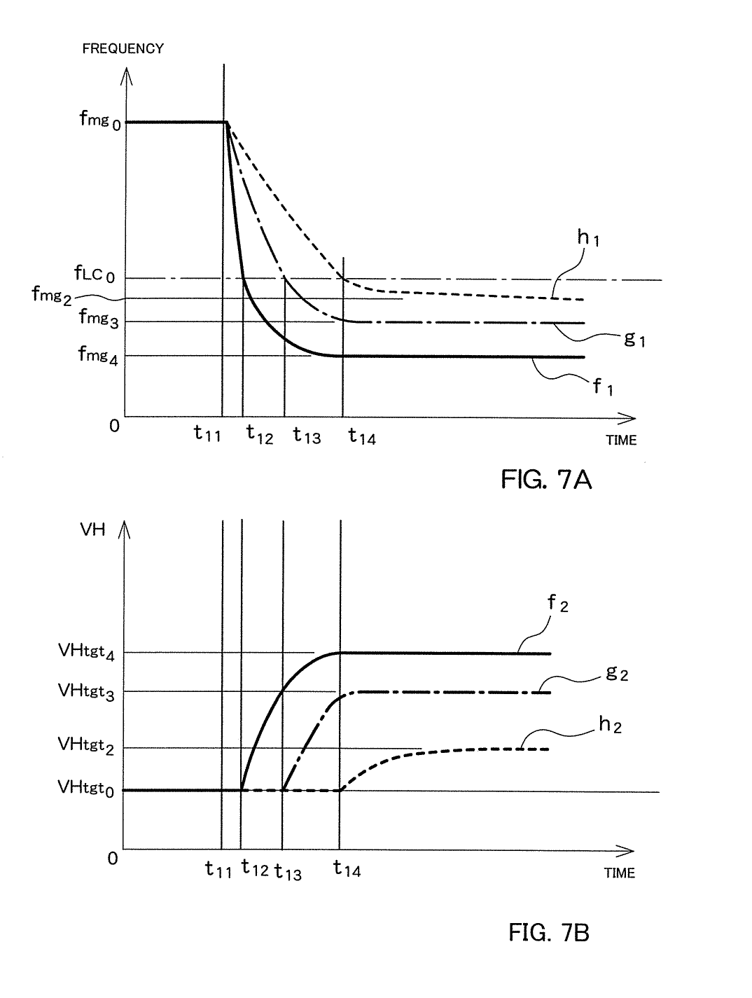

When the set value of the carrier frequency f_{mg} becomes the LC resonance upper limit frequency f_{LC0}, the control unit 60 detects the currents flowing in the switching elements 33a through 35a and 33b through 35b and the motor 50 as shown in step S209 in FIG. 6. As shown in step S210 in FIG. 6, the control unit 60 reads maps shown in FIGS. 7A and 7B, which are stored in the carrier frequency and voltage varying map 67 of the memory unit 62 shown in FIG. 1.

FIGS. 7A and 7B are maps specifying the calculated values of the first varied frequency and the varied voltage, and the rates of change of the set value of the carrier frequency f_{mg} and the set value of the high voltage VH (set value of output voltage of boost converter 20) with time in accordance with currents flowing in the switching elements 33a through 35a and 33b through 35b and the motor 50. A line “f₁” in FIG. 7A and a line “f₂” in FIG. 7B are curves specifying the rates of change of the set value of the carrier frequency f_{mg} and the set value of the high voltage VH (set value of output voltage of boost converter 20) with time, respectively, when currents flowing in the switching elements 33a through 35a and 33b through 35b and the motor 50 are large. When the temperatures of the respective switching elements 33a through 35a and 33b through 35b reach the first predetermined temperature at a time t₁₁, the carrier frequency f_{mg} is reduced to the LC resonance upper limit frequency f_{LC0} by a time t₁₂. Then, the carrier frequency f_{mg} is reduced to a first varied frequency f_{mg4}, and the set value of the high voltage VH (set value of output voltage of boost converter 20) is raised to a varied voltage VH_{tgt4}. A line “h₁” in FIG. 7A and a line “h₂” in FIG. 7B are curves specifying the rates of change of the set value of the carrier frequency f_{mg} and the set value of the high voltage VH (set value of output voltage of boost converter 20) with time, respectively, when currents flowing in the switching elements 33a through 35a and 33b through 35b and the motor 50 are small. When the temperatures of the respective switching elements 33a through 35a and 33b through 35b reach the first predetermined temperature at the time t₁₁, the set value of the carrier frequency f_{mg} is reduced to the LC resonance upper limit frequency f_{LC0} by a time t₁₄ later than the time t₁₂. Then, the set value of the carrier frequency f_{mg} is reduced to a first varied frequency f_{mg2} higher than the first varied frequency f_{mg4}, and the set value of the high voltage VH (set value of output voltage of boost converter 20) is raised to a varied voltage VH_{tgt2} lower than the varied voltage VH_{tgt4}.

More specifically, the set value of the high voltage VH (set value of output voltage of boost converter 20) indicated by the curves of the line “h₁” in FIG. 7A and the line “h₂” in FIG. 7B is maintained at the system loss minimization voltage VH_{tgt0} for the period from the time t₁₁ to the time t₁₄ in FIG. 7B, which is longer than the period from the time t₁₁ to the time t₁₂ when the set value of the high voltage VH (set value of output voltage of boost converter 20) indicated by the curves of the line “f₁” in FIG. 7A and the line “f₂” in FIG. 7B is maintained at the system loss minimization voltage VH_{tgt0}. In addition, the set value of the high voltage VH (set value of output voltage of boost converter 20) is controlled such that the raised set value of the high voltage VH does not exceed the varied voltage VH_{tgt2} which is lower than the varied voltage VH_{tgt4} of the curves “f₁” and “f₂” in FIGS. 7A and 7B. Accordingly, in the case of the curves indicated by the line “h₁” in FIG. 7A and the line “h₂” in FIG. 7B, the period for maintaining the set value of the high voltage VH (set value of output voltage of boost converter 20) at the system loss minimization voltage VH_{tgt0} is prolonged, and the rise of the set value of the high voltage VH (set value of output voltage of boost converter 20) is reduced to a small rise at the time of flow of small currents in the switching elements 33a through 35a and 33b through 35b and the motor 50. In this condition, a rise in the system loss decreases more effectively.

A line “g₁” in FIG. 7A and a line “g₂” in FIG. 7B are curves specifying the rates of change of the set value of the carrier frequency f_{mg} and the set value of the high voltage VH (set value of output voltage of boost converter 20), respectively, with time when currents flowing in the switching elements 33a through 35a and 33b through 35b and the motor 50 are medium. When the temperatures of the respective switching elements 33a through 35a and 33b through 35b reach the first predetermined temperature at the time t₁₁, the carrier frequency f_{mg} is reduced to the LC resonance upper limit frequency f_{LC0} by a time t₁₃ corresponding to an intermediate time between the time t₁₂ and the time t₁₄. Then, the carrier frequency f_{mg} is reduced to a first varied frequency f_{mg3} corresponding to an intermediate frequency between the first varied frequency f_{mg4} and the first varied frequency f_{mg2}, and the set value of the high voltage VH (set value of output voltage of boost converter 20) is raised to a varied voltage VH_{tgt3} corresponding to an intermediate voltage between the varied voltage VH_{tgt4} and the varied voltage VH_{tgt2}.

In step S210 in FIG. 6, the control unit 60 selects any one of combinations (f₁, f₂), (g₁, g₂), and (h₁, h₂) of the curves shown in the maps of FIGS. 7A and 7B stored in the carrier frequency and voltage varying map 67 of the memory unit 62 shown in FIG. 1 in accordance with the level of the currents flowing in the switching elements 33a through 35a and 33b through 35b and the motor 50 detected in step S209 in FIG. 6. Then, the control unit 60 changes the set value of the carrier frequency f_{mg} and the set value of the high voltage VH (set value of output voltage of boost converter 20) based on the selected curves.

When the high voltage VH (set value of output voltage of boost converter 20) reaches the varied voltage VH_{tgt4}, the varied voltage VH_{tgt3}, or the varied voltage VH_{tgt2} after the change of the set value of the carrier frequency f_{mg} and the high voltage VH (set value of output voltage of boost converter 20) based on any one of the curves (f₁, f₂), (g₁, g₂), and (h₁, h₂) shown in FIGS. 7A and 7B, the control unit 60 detects the temperatures of the respective switching elements 33a through 35a and 33b through 35b as shown in step S211 in FIG. 6, and checks whether the temperatures of the respective switching elements 33a through 35a and 33b through 35b become the first predetermined temperature or lower in comparison with the first predetermined temperature as shown in step S212 in FIG. 6. When the temperatures of the respective switching elements 33a through 35a and 33b through 35b are not the first predetermined temperature or lower, the control unit 60 repeats the operation for decreasing the set value of the carrier frequency f_{mg} by Δf_{mg1} and raising the set value of the high voltage VH (set value of output voltage of boost converter 20) by ΔVH until the temperatures of the switching elements 33a through 35a and 33b through 35b become the first predetermined temperature or lower as shown in steps S211 through S215 in FIG. 6, similarly to steps S109 through S113 in FIG. 2.

The operation according to this example of the embodiment offers advantages similar to the advantages provided by the operation described in conjunction with FIGS. 2 through 5. According to this example, however, the set value of the carrier frequency f_{mg} and the high voltage VH (set value of output voltage of boost converter 20) are varied based on the map specifying the calculated values of the first varied frequency and the varied voltage and the rates of change of the set value of the carrier frequency f_{mg} and the high voltage VH (set value of output voltage of boost converter 20) with time. This method requires a shorter calculation time than the time needed for repetitive calculation, making the control simple.

According to the operation discussed in this example of the embodiment, three combinations of the curves (f₁, f₂), (g₁, g₂), and (h₁, h₂) are stored in the carrier frequency and voltage varying map 67 shown in FIGS. 7A and 7B in correspondence with the level of the currents flowing in the switching elements 33a through 35a and 33b through 35b and the motor 50. However, the number of combinations of the curves is not limited to three. The number of the combinations may be an arbitrary number, or the combinations of the curves may be determined based on the temperatures of the switching elements 33a through 35a and 33b through 35b and the motor 50. In addition, a table specifying only the calculated values of the first varied frequency and the varied voltage, and a table specifying the rates of change with time may both be stored in the carrier frequency and voltage varying map 67 so that the set value of the carrier frequency f_{mg} and the set value of the high voltage VH (set value of output voltage of boost converter 20) can be varied in accordance with the values contained in the tables.

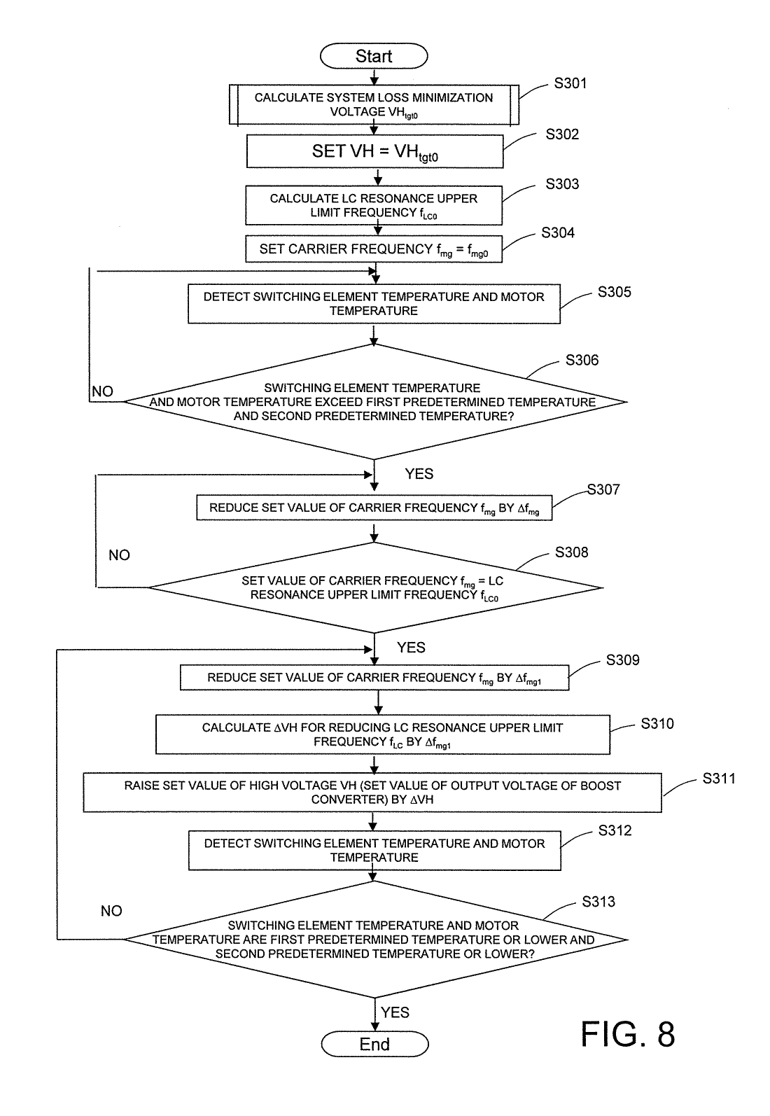

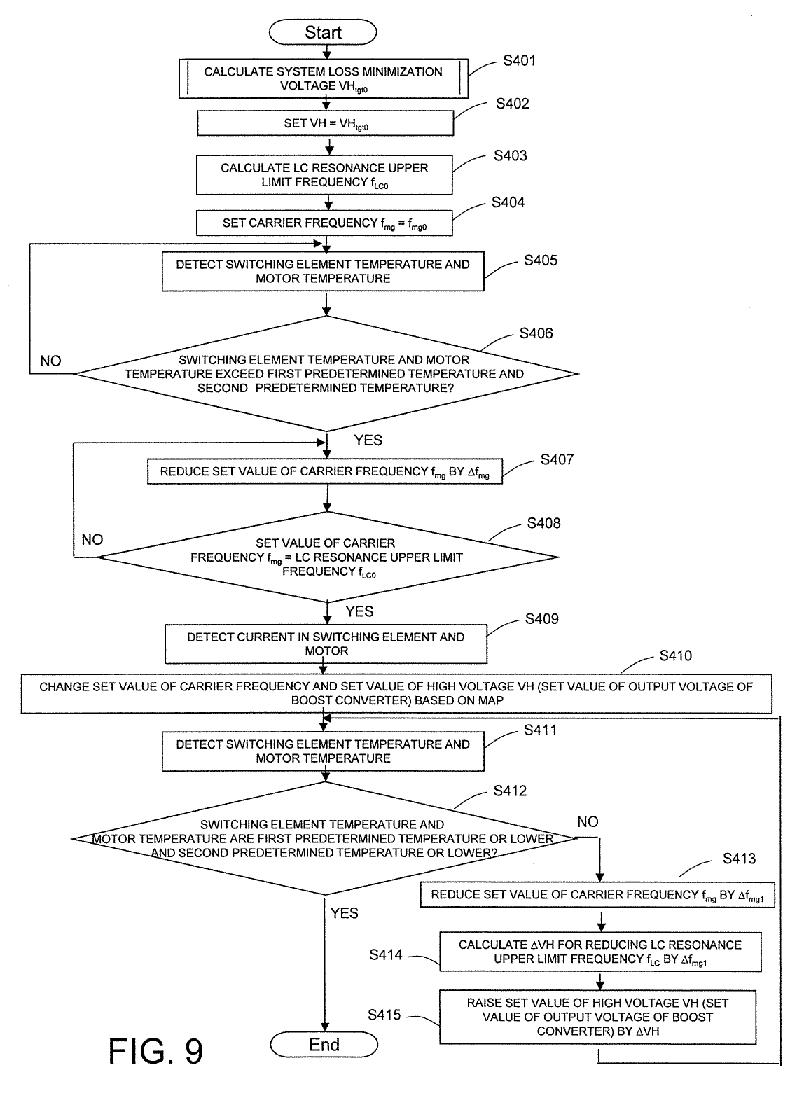

According to the embodiment described in conjunction with FIGS. 2 through 5 and FIG. 6, such an operation is performed which maintains the set value of the high voltage VH (set value of output voltage of boost converter 20) at the system loss minimization voltage VH_{tgt0} corresponding to the initial setting, and reduces the set value of the carrier frequency f_{mg} to the LC resonance upper limit frequency f_{LC0}, while controlling the temperatures of the respective switching elements 33a through 35a and 33b through 35b such that these temperatures do not exceed the first predetermined temperature. Then, the operation sets the set value of the carrier frequency f_{mg} to the first varied frequency f_{mg1} corresponding to the maximum frequency at which the temperatures of the respective switching elements 33a through 35a and 33b through 35b become the first predetermined temperature or lower, and sets the set value of the high voltage VH (set value of output voltage of boost converter 20) to the varied voltage VH_{tgt1} at which the LC resonance upper limit frequency f_{LC} becomes the first varied frequency f_{mg1}. However, as shown in FIGS. 8 and 9, such a method may be adopted which maintains the temperatures of the respective switching elements 33a through 35a and 33b through 35b at the first predetermined temperature or lower, and maintains the temperature of the motor 50 detected by the temperature sensor 51 shown in FIG. 1 at a second predetermined temperature or lower. Operations adopting this method are hereinbelow discussed with reference to FIGS. 8 and 9.

According to the operation of an example shown in FIG. 8, the temperatures of the respective switching elements 33a through 35a and 33b through 35b and the temperature of the motor 50 are obtained in step S305 similarly to the operation described in conjunction with FIGS. 2 through 5, and whether the temperatures of the respective switching elements 33a through 35a and 33b through 35b exceed the first predetermined temperature, and whether the temperature of the motor 50 exceeds the second predetermined temperature are monitored in step S306. In steps S309 through S313, the set value of the carrier frequency f_{mg} is changed to a second varied frequency f_{mg10}, and the set value of the high voltage VH (set value of output voltage of boost converter 20) is changed to a varied voltage VH_{tgt10} at which the LC resonance upper limit frequency f_{LC10} becomes a second varied frequency f_{mg10}, until the time when the temperatures of the respective switching elements 33a through 35a and 33b through 35b become the first predetermined temperature or lower and when the temperature of the motor 50 becomes the second predetermined temperature or lower.

According to the operation of an example shown in FIG. 9, the temperatures of the respective switching elements 33a through 35a and 33b through 35b and the temperature of the motor 50 are obtained in step S405 similarly to the operation described in conjunction with FIG. 6, and whether the temperatures of the respective switching elements 33a through 35a and 33b through 35b exceed the first predetermined temperature, and whether the temperature of the motor 50 exceeds the second predetermined temperature are monitored in step S406. In steps S411 through S415, the set value of the carrier frequency f_{mg} is changed to the second varied frequency f_{mg10}, and the set value of the high voltage VH (set value of output voltage of boost converter 20) is changed to the varied voltage VH_{tgt10} at which the LC resonance upper limit frequency f_{LC10} becomes the second varied frequency f_{mg10}, until the time when the temperatures of the respective switching elements 33a through 35a and 33b through 35b become the first predetermined temperature or lower and when the temperature of the motor 50 becomes the second predetermined temperature or lower. For performing the operation shown in FIG. 9, a map is used that contains combinations of curves which maintain the temperatures of the switching elements 33a through 35a and 33b through 35b at the first predetermined temperature or lower, and maintain the temperature of the motor 50 at the second predetermined temperature or lower, in lieu of the map described in conjunction with FIGS. 7A and 7B.

The operations shown in FIGS. 8 and 9 offer the advantage of preventing deterioration of the total power loss of the system while reducing not only increase in the temperatures of the switching elements 33a through 35a and 33b through 35b, but also increase in the temperature of the motor at the time of increase in the temperature of the motor.

1. A power controller, comprising:
a battery;
a boost converter containing a reactor, and boosting voltage of DC power supplied from the battery to output the voltage-boosted DC power;
an inverter containing a smoothing capacitor, and converting the voltage-boosted DC power supplied from the boost converter into AC power by turning a plurality of switching elements on and off at a carrier frequency to supply the AC power to a motor;
temperature sensors detecting the temperatures of the respective switching elements; and
a control unit controlling the output voltage of the boost converter and the carrier frequency of the inverter,
wherein
an LC circuit is formed by the reactor and the smoothing capacitor,
the carrier frequency is set to a frequency higher than an LC resonance upper limit frequency corresponding to the maximum frequency at which LC resonance is generated in the LC circuit,
the control unit includes
carrier frequency reducing means which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and
voltage varying means which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.

2. The power controller of claim 1, wherein the carrier frequency reducing means reduces the set value of the carrier frequency from the set frequency to the LC resonance upper limit frequency while maintaining the temperatures of the respective switching elements detected by the respective temperature sensors at least at the first predetermined temperature.

3. The power controller of claim 1, wherein the carrier frequency reducing means determines the reduction rate of the carrier frequency with time in accordance with the increase rates of the temperatures of the respective switching elements with time detected by the temperature sensors prior to the start of reduction of the set value of the carrier frequency.

4. The power controller of claim 2, wherein the carrier frequency reducing means determines the reduction rate of the carrier frequency with time in accordance with the increase rates of the temperatures of the respective switching elements with time detected by the temperature sensors prior to the start of reduction of the set value of the carrier frequency.

5. The power controller of claim 1, further comprising:
a motor temperature sensor detecting the temperature of the motor,
wherein the voltage varying means changes the set value of the carrier frequency to a second varied frequency calculated based on a second predetermined temperature and the temperature of the motor detected by the motor temperature sensor, and changes the set value of the output voltage of the boost converter to a voltage at which the LC resonance upper limit frequency becomes the second varied frequency at the time of reduction of the set value of the carrier frequency from the set frequency to the LC resonance upper limit frequency.

6. The power controller of claim 2, further comprising:
a motor temperature sensor detecting the temperature of the motor,
wherein the voltage varying means changes the set value of the carrier frequency to a second varied frequency calculated based on a second predetermined temperature and the temperature of the motor detected by the motor temperature sensor, and changes the set value of the output voltage of the boost converter to a voltage at which the LC resonance upper limit frequency becomes a second varied frequency at the time of reduction of the set value of the carrier frequency from the set frequency to the LC resonance upper limit frequency.

7. The power controller of claim 3, further comprising:
a motor temperature sensor detecting the temperature of the motor,
wherein the voltage varying means changes the set value of the carrier frequency to a second varied frequency calculated based on a second predetermined temperature and the temperature of the motor detected by the motor temperature sensor, and changes the set value of the output voltage of the boost converter to a voltage at which the LC resonance upper limit frequency becomes the second varied frequency at the time of reduction of the set value of the carrier frequency from the set frequency to the LC resonance upper limit frequency.

8. The power controller of claim 4, further comprising:
a motor temperature sensor detecting the temperature of the motor,
wherein the voltage varying means changes the set value of the carrier frequency to a second varied frequency calculated based on a second predetermined temperature and the temperature of the motor detected by the motor temperature sensor, and changes the set value of the output voltage of the boost converter to a voltage at which the LC resonance upper limit frequency becomes the second varied frequency at the time of reduction of the set value of the carrier frequency from the set frequency to the LC resonance upper limit frequency.

9. The power controller of claim 5, wherein the carrier frequency reducing means reduces the set value of the carrier frequency from the set frequency to the LC resonance upper limit frequency while maintaining the temperature of the motor detected by the motor temperature sensor at the second predetermined temperature.

10. The power controller of claim 6, wherein the carrier frequency reducing means reduces the set value of the carrier frequency from the set frequency to the LC resonance upper limit frequency while maintaining the temperature of the motor detected by the motor temperature sensor at the second predetermined temperature.

11. The power controller of claim 7, wherein the carrier frequency reducing means reduces the set value of the carrier frequency from the set frequency to the LC resonance upper limit frequency while maintaining the temperature of the motor detected by the motor temperature sensor at the second predetermined temperature.

12. The power controller of claim 8, wherein the carrier frequency reducing means reduces the set value of the carrier frequency from the set frequency to the LC resonance upper limit frequency while maintaining the temperature of the motor detected by the motor temperature sensor at the second predetermined temperature.

13. The power controller of claim 5, wherein the carrier frequency reducing means determines the reduction rate of the carrier frequency with time in accordance with the increase rate of the temperature of the motor with time detected by the motor temperature sensor prior to the start of reduction of the set value of the carrier frequency.

14. The power controller of claim 6, wherein the carrier frequency reducing means determines the reduction rate of the carrier frequency with time in accordance with the increase rate of the temperature of the motor with time detected by the motor temperature sensor prior to the start of reduction of the set value of the carrier frequency.

15. The power controller of claim 7, wherein the carrier frequency reducing means determines the reduction rate of the carrier frequency with time in accordance with the increase rate of the temperature of the motor with time detected by the motor temperature sensor prior to the start of reduction of the set value of the carrier frequency.

16. The power controller of claim 8, wherein the carrier frequency reducing means determines the reduction rate of the carrier frequency with time in accordance with the increase rate of the temperature of the motor with time detected by the motor temperature sensor prior to the start of reduction of the set value of the carrier frequency.

17. A power controller, comprising:
a battery;
a boost converter containing a reactor, and boosting voltage of DC power supplied from the battery to output the voltage-boosted DC power;
an inverter containing a smoothing capacitor, and converting the voltage-boosted DC power supplied from the boost converter into AC power by turning a plurality of switching elements on and off at a carrier frequency to supply the AC power to a motor;
temperature sensors detecting the temperatures of the respective switching elements; and
a control unit containing a CPU and controlling the output voltage of the boost converter and the carrier frequency of the inverter,
wherein
an LC circuit is formed by the reactor and the smoothing capacitor,
the carrier frequency is set to a frequency higher than an LC resonance upper limit frequency corresponding to the maximum frequency at which LC resonance is generated in the LC circuit,
the control unit performs, using the CPU,
a carrier frequency reducing program which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and
a voltage varying program which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.

18. An operation method of a power controller, wherein
the power controller includes:
a battery;
a boost converter containing a reactor, and boosting voltage of DC power supplied from the battery to output the voltage-boosted DC power;
an inverter containing a smoothing capacitor, and converting the voltage-boosted DC power supplied from the boost converter into AC power by turning a plurality of switching elements on and off at a carrier frequency to supply the AC power to a motor; and
temperature sensors detecting the temperatures of the respective switching elements, wherein
an LC circuit is formed by the reactor and the smoothing capacitor of the power controller,
the carrier frequency of the power controller is set to a frequency higher than an LC resonance upper limit frequency corresponding to the maximum frequency at which LC resonance is generated in the LC circuit, and
the method includes
a carrier frequency reducing step which reduces a set value of the carrier frequency from a set frequency to the LC resonance upper limit frequency at the time of reduction of the carrier frequency from the set frequency while maintaining a set value of the output voltage of the boost converter at a system loss minimization voltage calculated based on the total power loss of the boost converter, the inverter, and the motor, and
a voltage varying step which changes the set value of the carrier frequency at least to a first varied frequency calculated based on a first predetermined temperature and the temperatures of the respective switching elements detected by the respective temperature sensors, and changes the set value of the output voltage of the boost converter to a voltage at which the LC resonance upper limit frequency becomes the first varied frequency at the time of reduction of the set value of the carrier frequency from the set frequency to the LC resonance upper limit frequency.
